(19) United States
(12) Patent Application Publication
(10) Pub. No.: US 2024/0202836 A1
(43) Pub. Date: Jun. 20, 2024

(54) MEDIA DATA MANAGEMENT IN SOCIAL APPLICATION

(71) Applicant: Lemon Inc., Grand Cayman (KY)

(72) Inventors: Xinxi CHEN, Los Angeles, CA (US); Zhe LIU, Los Angeles, CA (US); Shanmukha POTTI, Los Angeles, CA (US); Cheng CHENG, Los Angeles, CA (US); Xincheng XIONG, Los Angeles, CA (US); Bin LIU, Los Angeles, CA (US)

(21) Appl. No.: 18/068,345

(22) Filed: Dec. 19, 2022

(51) Int. Cl. G06Q 50/00; G06F 3/0481; G06F 16/2457

(52) U.S. Cl. CPC G06Q 50/01; G06F 3/0481; G06F 16/24575

(57) ABSTRACT

There are provided methods, devices, and computer program products for providing media data in a social application. In the method, a first user account of the social application is determined, and the first user account is a business user account of the social application. An interaction event is obtained between a second user account of the social application and the first user account, and the second user account being a personal user account of the social application. Media data associated with the first user account is provided to the second user account based on the interaction event. With these implementations, the data communications between the business user account and the personal user account may be implemented in a flexible and effective way.

### FIELD

The present disclosure generally relates to media data management, and more specifically, to methods, devices and computer program products for providing media data in a social application.

### BACKGROUND

Nowadays, various social applications are developed for interpersonal communication. Some social applications may support both business users and personal users. For example, a business user such as an electronic device manufacturer may register a business user account in the social application and post articles about its new products, a game development company may register its business user account to post articles about its new games, and the like. A personal user account may be registered by a common person, and the personal user account may follow the business user account and/or view articles posted by the business user accounts. At this point, the business user accounts may post articles and/or feed the articles to the followers, however, they cannot select candidate audiences from the personal user accounts and communicate with the candidate audiences actively. At this point, how to facilitate effective data communication in the social application becomes a hot focus.

### SUMMARY

In a first aspect of the present disclosure, there is proposed a method for providing media data in a social application. In the method, a first user account of the social application is determined, and the first user account is a business user account of the social application. An interaction event is obtained between a second user account of the social application and the first user account, and the second user account is a personal user account of the social application. Media data associated with the first user account is provided to the second user account based on the interaction event.

In a second aspect of the present disclosure, there is proposed an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is proposed a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates an example environment for a social application according to implementations of the present disclosure;

FIG. 2 illustrates an example diagram for providing media data in a social application according to implementations of the present disclosure;

FIG. 3 illustrates an example diagram for a user interface of a personal user account according to implementations of the present disclosure;

FIG. 4 illustrates an example diagram for an interaction event according to implementations of the present disclosure;

FIG. 5 illustrates an example diagram for multiple types of objects that are associated with an interaction event according to implementations of the present disclosure;

FIG. 6 illustrates an example diagram for searching in a media database for a media data according to implementations of the present disclosure;

FIG. 7 illustrates an example diagram for providing a media data to a personal user account according to implementations of the present disclosure;

FIG. 8 illustrates an example flowchart of a method for providing media data in a social application according to implementations of the present disclosure; and

FIG. 9 illustrates a block diagram of a computing device in which various implementations of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

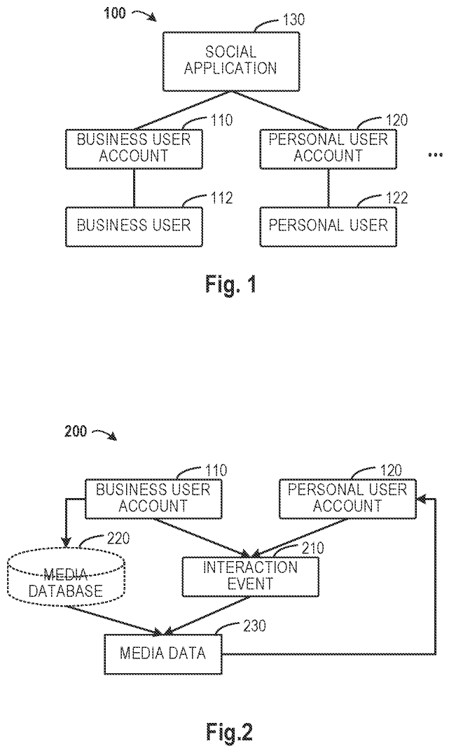

For the purpose of description, the following paragraphs will provide more details by taking a social application as an example environment. FIG. 1 illustrates an example environment 100 for a social application 130 according to implementations of the present disclosure. As illustrated in FIG. 1, users may register their accounts in the social application 130. For example, a business user 112 (such as the electronic device manufacturer, the game development company, and the like) may register a business user account 110 (also referred to as a first user account in the social application 130), and a personal user 122 (such as a common individual user) may register a personal user account 120 (also referred to as a second user account in the social application 130).

Here, the business user 112 may use the business user account 110 to post articles about their new products and/or other news in the social application 130. Here, the article may involve various formats, for example, a text format, an image format, an audio format, a video format, and the like. Hereinafter, a video sharing social application will be taken as an example of the social application 130, at this point, the articles may be videos that are posted in the video sharing social application.

The personal user 122 may use the personal user account 120 to access the business user account 110 and view the posted articles. If the personal user account 120 follows the business user account 110, then the personal user account 120 can be informed when the business user account 110 posts a new article. However, the business user 112 cannot positively select its candidate audiences and provide data (such as promotion data and/or other advertisements) to the candidate audiences. At this point, how to provide more flexible and convenient data communications between different user accounts has become a research hotspot.

In view of the above, the present disclosure proposes a media data management solution, and referring to FIG. 2 for a brief description of the proposed solution. FIG. 2 illustrates an example diagram 200 for providing media data in a social application according to implementations of the present disclosure. As illustrated in FIG. 2, two different user accounts may be obtained in the social application 130, here the business user account 110 may be registered by the business user 112 and the personal user account 120 may be registered by a common personal user 122. Then, an interaction event 210 between the business user account 110 and the personal user account 120 may be obtained in the social application 130. The interaction event 210 may comprise various types, for example, the personal user account 120 may follow the business user account 110, view articles posted by the business user account 110, and the like.

If the interaction event 210 is detected between the business user account 110 and the personal user account 120, then media data 230 may be retrieved (for example, from a media database 220) and provided to the personal user account 120. With these implementations of the present disclosure, there is proposed a new way for data communication between the business user account 110 and the personal user account 120. In other words, the present disclosure allows the business user account 110 to actively select its candidate audiences (such as the personal user account 120) based on the interaction event 210 and further provide the media data 230 to the selected audiences. Even if the personal user account 120 does not follow the business user account 110, the media data 230 which is associated with the business user account 110 can still be provided to the personal user account 120. Therefore, the data communication between the business user account 110 and the personal user account 120 may be implemented in a more flexible and effective way.

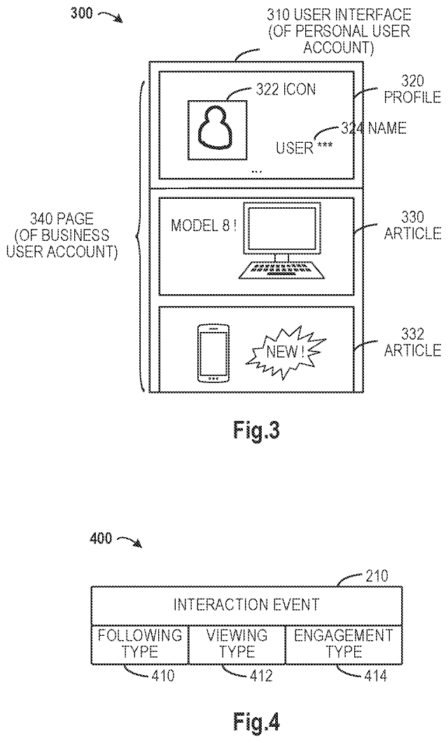

Reference will be made to FIG. 3 for more details about the interaction event 210, here FIG. 3 illustrates an example diagram 300 for a user interface 310 of a personal user account 120 according to implementations of the present disclosure. As illustrated in FIG. 3, the user personal user 122 may log in his/her personal user account 120 of the social application 130 to access the business user account 110. For example, the user interface 310 of the personal user account 120 may show a page 340 of the business user account 110. The page 340 may comprise a profile 320 of the business user account 110, and articles 330, 332, . . . that are posted by the business account.

As shown, the profile 320 may comprise: an icon 322 selected by the business user 112, a name 324 of the business user 112, and the like. Further, the page 340 may comprise one or more articles. For example, the article 330 may introduce a new computer device “Model 8,” and the article 332 may relates to a new released cell phone. Here, the personal user 122 may visit the page 340 and perform various actions on the page 340, for example, the personal user account 120 may follow the business user account 110, view detailed information in the profile 320, view articles in the page 340, and the like.

The interaction event 210 may comprise multiple types according to the performed actions. FIG. 4 illustrates an example diagram 400 for an interaction event 210 according to implementations of the present disclosure. As illustrated in FIG. 4, the interaction event 210 may comprise: a following type 410, which indicates that the personal user account 120 follows the business user account 110; a viewing type 412, which indicates that the personal user account 110 views content (such as the profile 320, the articles 330 and 332, and so on) associated with the business user account 110; and an engagement type 414, which indicates that the personal user account 120 performs a further interaction (such as submitting a comment, a like comment, a dislike comment, forwarding an article, and the like) with the article. Here, the article may be an article that is posted by the business user account 110, or an article originally posted by the business user account 110 but is currently forwarded by another user account.

In some implementations of the present disclosure, the viewing type 412 may be further divided into multiple sub-types. For example, based on the percentage of the article (i.e., the video) that is viewed by the personal user account 120, the viewing type 412 may further comprise: (1) Type I, where 100% of the video is viewed; (2) Type II, where 50-99% of the video is viewed; and (3) Type III, where less than 50% of the video is viewed. Alternatively and/or in additional to, the sub-types may be divided based on the time length of the portion that is viewed of the video.

In some implementations of the present disclosure, a condition may be defined in advance. For example, the condition may specify that if the detected interaction event belongs to any of the above types, then the media data 230 may be retrieved and then provided to the personal user account 120. For example, if the personal user account 120 follows the business user account 110, views the article 330 or forwards the article 330, then the media data 230 may be provided to the personal user account 120. Alternatively and/or in additional to, multiple interaction events may be detected and then the media data 230 may be provided to the personal user account 120 based on the multiple interaction events. For example, the condition may specify that the media data 230 may be provided if two interaction events with two different types are detected. At this point, if the personal user account 120 views an article (corresponding to the viewing type 412) and then forward the article (corresponding to the engagement type 414), then the media data 230 may be retrieved and then provided to the personal user account 120. With these implementations of the present disclosure, according to the predefined conditions, the media data 230 may be provided to the personal user account 120 in a more flexible and effective way based on details of the interaction event 210.

In some implementations of the present disclosure, the interaction event 210 may be collected periodically when the personal user 122 uses the social application 130. For example, once it is detected that the interaction event 210 meets the predefined condition, the media data 230 may be retrieved and provided to the personal user account 120. Here, the media data 230 may include any of the text, the image, the audio, or the video formats. Hereinafter, the present disclosure will be described by taking the video as an example of the media data 230. In the situation of the video sharing social application, the media data 230 may also be a video, however, the media data 230 should be different from the article that is posted by the business user account 110. In other words, the media data 230 is associated with the business user account 110 and is selected from a source other than the page 340 of the business account 110.

In some implementations of the present disclosure, the media data 230 may be obtained from the media database 220 that is associated with the business user account 110. Here, the media database 220 may be a video database maintained by the business user 112, and/or by an agency for creating advertisements or other videos for the business user 112. At this point, the media database 220 may be searched to find the media data 230 that may attract the personal user's attention.

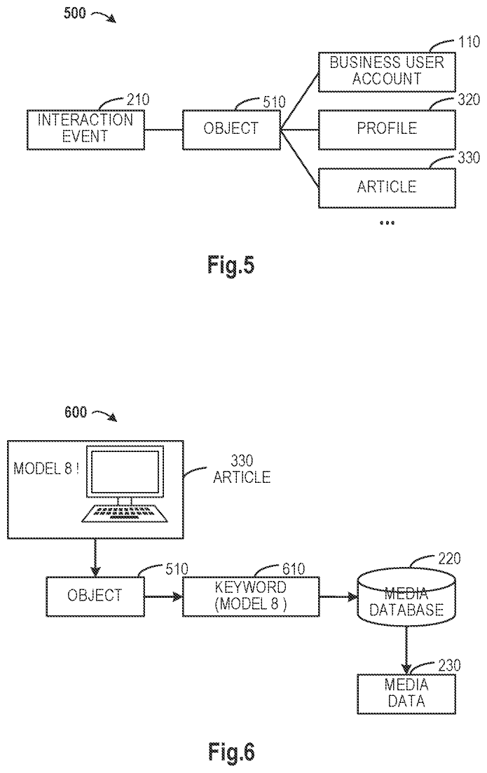

In some implementations of the present disclosure, a keyword may be determined based on the interaction event 210. Specifically, an object that is associated with the interaction event 210 may be identified. Referring to FIG. 5 for more details for determining the keyword based on the interaction event 210, here FIG. 5 illustrates an example diagram 500 for multiple types of objects that are associated with an interaction event according to implementations of the present disclosure. As illustrated in FIG. 5, the interaction event 210 may be associated with an object 510, here the object 510 indicates an object on which the interaction event 210 occurs. For example, if the personal user account 120 follows the business user account 110, then the object 510 may indicate the business user account 110 itself. If the personal user account 120 views the profile 320 of the business user account 110, then the object 510 may indicate the profile 320. If the personal user account 120 views or forwards the article 330 that is posted by the business user account 110, then the object 510 may indicate the article 330. If the personal user account 120 submit a comment to the article 330 that is posted by the business user account 110, then the object 510 may indicate the article 330.

Here, the object 510 may reflect the personal user's interest in a more accurate way, and thus an accurate keyword may be determined so as to find an appropriate media data 230 for the personal user 122. Referring to FIG. 6 for a detailed procedure for retrieving the media data 230, here FIG. 6 illustrates an example diagram 600 for searching in a media database for a media data according to implementations of the present disclosure. As illustrated in FIG. 6, supposing the personal user account 120 views the article 330 that is posted by the business account 110, the article 330 may be considered as the object 510, and then the keyword 610 may be determined based on an analysis to the object 510. In the above example where the article 330 introduces the model 8 computer, the keyword 610 may be set to “model 8” or other parameters related to the model 8 computer. Further, the media database 220 may be searched with the keyword 610 and then the media data 230 may be found.

In some implementations, the percentage of portion that is viewed in the article 330 (for example, a video introducing the model 8 computer) may be considered in providing the media data 230. Specifically, if the personal user account 122 finishes viewing the whole video, it shows a high interest level, and then a media data that includes detailed information about the model 8 computer may be retrieved and provided to the personal user account 120. If only 50% of the video is viewed, it shows a medium interest level, and then a media data that includes brief information about the model 8 computer may be retrieved and provided to the personal user account 120. With these implementations of the present disclosure, the media data 230 may be obtained based on the historical interaction event of the personal user account 120, and thus the media data 230 may be retrieved in a more effective way and meet the personal user's requirements.

In some implementations of the present application, the media data 230 may be provided to the personal user account 120 during the personal user account viewing articles that are posted in the social application 130. In one example, the media data 230 may be provided to the personal user account 120 if it is detected that the personal user account 120 finishes viewing an article that is posted in the social application. Specifically, in the situation where the article is a video, the media data 230 may be played after the video is finished. In another example, the media data 230 may be provided to the personal user account 120 if it is detected that the personal user account 120 submits a request to switch to a next article that is posted in the social application.

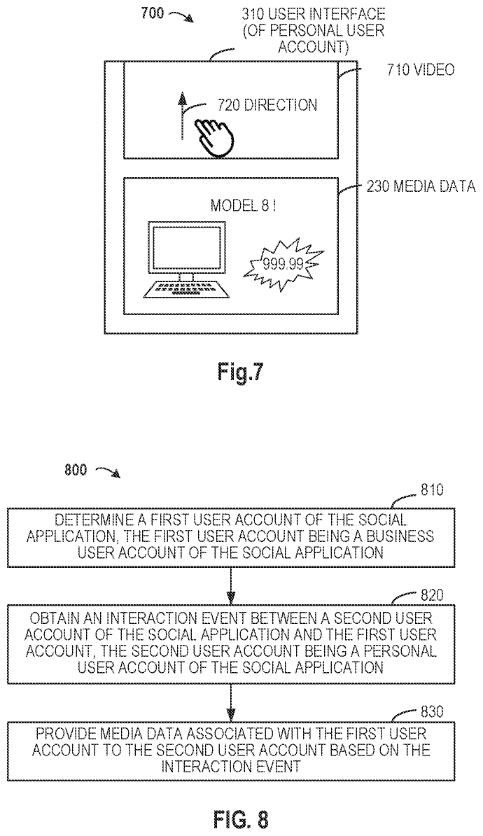

FIG. 7 illustrates an example diagram 700 for providing a media data to a personal user account according to implementations of the present disclosure. As illustrated in FIG. 7, a video 710 may be played on the user interface 310 of the personal user account 120, here the personal user 122 may request to switch to a further video by a predefined action. For example, the personal user 122 may swipe along a direction 720 for requesting the further video. At this point, the media data 230 may enter into the user interface 310 from the bottom and then be displayed in the user interface 310. With these implementations of the present disclosure, various factors may trigger the media data providing, and thus the media data 230 may be provided to the personal user account 120 in a more flexible way.

In some implementations of the present disclosure, an occurrence time point of the interaction event 210 may also be considered in providing the media data 230. With respect to the following type 410, if the personal user account 120 follows the business user account 110, then the media data 230 may be provided to the personal user account 120 according to a specific frequency (for example, every two days, every week, and the like) until the personal user account 120 unfollows the business user account 110.

With respect to the viewing type 412 and the engagement type 414, a threshold time duration (such as one week, two weeks, one month, and the like) may be defined in advance. Then the occurrence time point may be compared with the threshold time duration, if the occurrence time point is within the threshold time duration, then the media data 230 may be provided to the personal user account 120. If the occurrence time point is not within the threshold time duration, then the media data 230 may not be provided to the personal user account 120.

In some implementations of the present disclosure, the threshold time duration may be set to different values according to the interest level indicated by the interaction event 210. For example, the threshold time duration may be set to a larger value for an interaction event showing a higher interest level, and the threshold time duration may be set to a smaller value for an interaction event showing a lower interest level. Specifically, with respect to a viewing event where the whole video is viewed, the threshold time duration may be set to a long time duration (for example, two weeks), and with respect to a viewing event where 50% of the video is viewed, the threshold time duration may be set to a short time duration (for example, one week). With these implementations, the various interaction events may be processed according to corresponding threshold time durations, so as to provide the media data 230 in a more flexible and effective way.

The preceding paragraphs have described the situation for providing the media data 230 to a single personal user account. In some implementations of the present application, one or more personal user accounts may be added into an audience list based on the historical interaction events, and then the personal user account(s) in the audience list may be provided with the media data 230. With these implementations of the present disclosure, the interest level of the personal users may be determined by analyzing various aspects of the interaction events, and then more appropriate media data may be retrieved and provided to multiple personal user accounts with the similar interest level.

In some implementations of the present disclosure, if it is determined that a personal user account interacts with the business user account 110, then the personal user account may be added to the audience list. Further, more conditions may be defined in advance for the audience list. For example, it may be defined that if a personal user account follows the business user account 110, the personal user account may be added into the list immediately. If a personal user account unfollows the business user account 110, the personal user account may be removed from the audience list. If a personal user account views an article that is associated with the business user account 110 and the time duration (or percentage of the viewed portion) reaches a predefined value, the personal user account may be added into the list. If a personal user account forwards an article that is associated with the business user account 110, the personal user account may be added into the list. If a personal user account submits a comment (for example, a text comment expressing his/her interest or a like comment) to an article that is associated with the business user account 110, the personal user account may be added into the list. If a personal user account submits a comment (for example, a negative text comment or a dislike comment) to an article that is associated with the business user account 110, the personal user account may be excluded from the list.

With implementations of the present disclosure, the audience list allows the business user 122 to actively select its candidate audience based on the historical interaction event between the business user account 110 and the personal user account 120.

In some implementations of the present disclosure, the media database 220 may be updated periodically. For example, a new advertisement about the model 8 computer may be added into the media database 220, and then the new advertisement may be provided to the personal user account 120. In some implementations of the present disclosure, a feedback box (that inquires whether the personal user 122 wants to receive further media data about the business user account 110) may be provided to the personal user account 120 together with the media data 230. Then, further media data may be provided if the feedback box is checked, and no further media data may be provided if the feedback box is not checked. With these implementations of the present disclosure, the personal user is allowed to receive or reject the further media data.

The above paragraphs have described details for providing media data. According to implementations of the present disclosure, a method is proposed for providing media data in a social application. Reference will be made to FIG. 8 for more details about the method, where FIG. 8 illustrates an example flowchart of a method 800 for providing media data in a social application according to implementations of the present disclosure. At a block 810, a first user account of the social application is determined, the first user account being a business user account of the social application. At a block 820, an interaction event between a second user account of the social application and the first user account is obtained, the second user account being a personal user account of the social application. At a block 830, media data associated with the first user account is provided to the second user account based on the interaction event.

In some implementations of the present disclosure, the media data is different from an article that is posted by the first user account.

In some implementations of the present disclosure, providing the media data to the second user account comprises: obtaining the media data from a media database associated with the first user account; and providing the media data to the second user account during the second user account viewing articles that are posted in the social application.

In some implementations of the present disclosure, obtaining the media data from the media database comprises: selecting a keyword for obtaining the media data based on the interaction event; and retrieving the media data from the media database based on the keyword.

In some implementations of the present disclosure, selecting the keyword comprises: identifying an object that is associated with the interaction event; and selecting the keyword based on the object.

In some implementations of the present disclosure, providing the media data to the second user account comprises: providing the media data to the second user account in response to any of: a detection that the second user account finishes viewing an article that is posted in the social application; a detection that the second user account submits a request to switch to a next article that is posted in the social application.

In some implementations of the present disclosure, the interaction event comprises any of: the second user account following the first user account; the second user account viewing a profile of the first user account; the second user account viewing an article that is associated with the first user account; the second user account submitting a comment on an article that is associated with the first user account; the second user account submitting a like comment to an article that is associated with the first user account; the second user account forwarding an article that is associated with the first user account.

In some implementations of the present disclosure, providing the media data comprises: providing the media data to the second user account in response to a determination that an occurrence time point of the interaction event meets a predetermined condition.

According to implementations of the present disclosure, an apparatus is provided for providing media data in a social application. The apparatus comprises: a determining unit, configured for determining a first user account of the social application, the first user account being a business user account of the social application; an obtaining unit, configured for obtaining an interaction event between a second user account of the social application and the first user account, the second user account being a personal user account of the social application; and a providing unit, configured for providing media data associated with the first user account to the second user account based on the interaction event. Further, the apparatus may comprise other units for implementing other steps in the method 800.

According to implementations of the present disclosure, an electronic device is provided for implementing the method 800. The electronic device comprises: a computer processor coupled to a computer-readable memory unit, the memory unit comprising instructions that when executed by the computer processor implements a method for providing media data in a social application. The method comprises: determining a first user account of the social application, the first user account being a business user account of the social application; obtaining an interaction event between a second user account of the social application and the first user account, the second user account being a personal user account of the social application; and providing media data associated with the first user account to the second user account based on the interaction event.

In some implementations of the present disclosure, the media data is different from an article that is posted by the first user account.

In some implementations of the present disclosure, providing the media data to the second user account comprises: obtaining the media data from a media database associated with the first user account; and providing the media data to the second user account during the second user account viewing articles that are posted in the social application.

In some implementations of the present disclosure, obtaining the media data from the media database comprises: selecting a keyword for obtaining the media data based on the interaction event; and retrieving the media data from the media database based on the keyword.

In some implementations of the present disclosure, selecting the keyword comprises: identifying an object that is associated with the interaction event; and selecting the keyword based on the object.

In some implementations of the present disclosure, providing the media data to the second user account comprises: providing the media data to the second user account in response to any of: a detection that the second user account finishes viewing an article that is posted in the social application; a detection that the second user account submits a request to switch to a next article that is posted in the social application.

In some implementations of the present disclosure, the interaction event comprises any of: the second user account following the first user account; the second user account viewing a profile of the first user account; the second user account viewing an article that is associated with the first user account; the second user account submitting a comment on an article that is associated with the first user account; the second user account submitting a like comment to an article that is associated with the first user account; the second user account forwarding an article that is associated with the first user account.

In some implementations of the present disclosure, providing the media data comprises: providing the media data to the second user account in response to a determination that an occurrence time point of the interaction event meets a predetermined condition.

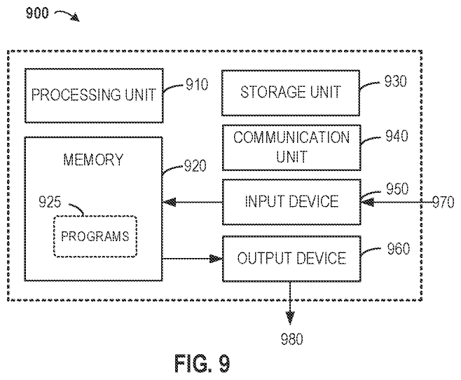

FIG. 9 illustrates a block diagram of a computing device 900 in which various implementations of the present disclosure can be implemented. It would be appreciated that the computing device 900 shown in FIG. 9 is merely for purpose of illustration, without suggesting any limitation to the functions and scopes of the present disclosure in any manner. The computing device 900 may be used to implement the above method 800 in implementations of the present disclosure. As shown in FIG. 9, the computing device 900 may be a general-purpose computing device. The computing device 900 may at least comprise one or more processors or processing units 910, a memory 920, a storage unit 930, one or more communication units 940, one or more input devices 950, and one or more output devices 960.

The processing unit 910 may be a physical or virtual processor and can implement various processes based on programs stored in the memory 920. In a multi-processor system, multiple processing units execute computer executable instructions in parallel so as to improve the parallel processing capability of the computing device 900. The processing unit 910 may also be referred to as a central processing unit (CPU), a microprocessor, a controller, or a microcontroller.

The computing device 900 typically includes various computer storage medium. Such medium can be any medium accessible by the computing device 900, including, but not limited to, volatile and non-volatile medium, or detachable and non-detachable medium. The memory 920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 930 may be any detachable or non-detachable medium and may include a machine-readable medium such as a memory, flash memory drive, magnetic disk, or another other media, which can be used for storing information and/or data and can be accessed in the computing device 900.

The computing device 900 may further include additional detachable/non-detachable, volatile/non-volatile memory medium. Although not shown in FIG. 9, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 940 communicates with a further computing device via the communication medium. In addition, the functions of the components in the computing device 900 can be implemented by a single computing cluster or multiple computing machines that can communicate via communication connections. Therefore, the computing device 900 can operate in a networked environment using a logical connection with one or more other servers, networked personal computers (PCs) or further general network nodes.

The input device 950 may be one or more of a variety of input devices, such as a mouse, keyboard, tracking ball, voice-input device, and the like. The output device 960 may be one or more of a variety of output devices, such as a display, loudspeaker, printer, and the like. By means of the communication unit 940, the computing device 900 can further communicate with one or more external devices (not shown) such as the storage devices and display device, with one or more devices enabling the user to interact with the computing device 900, or any devices (such as a network card, a modem, and the like) enabling the computing device 900 to communicate with one or more other computing devices, if required. Such communication can be performed via input/output (I/O) interfaces (not shown).

In some implementations, instead of being integrated in a single device, some, or all components of the computing device 900 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

What is claimed is:

1. A method for providing media data in a social application, comprising:
determining a first user account of the social application, the first user account being a business user account of the social application;
obtaining an interaction event between a second user account of the social application and the first user account, the second user account being a personal user account of the social application; and
providing media data associated with the first user account to the second user account based on the interaction event.

2. The method according to claim 1, wherein the media data is different from an article that is posted by the first user account.

3. The method according to claim 1, wherein providing the media data to the second user account comprises:
obtaining the media data from a media database associated with the first user account; and
providing the media data to the second user account during the second user account viewing articles that are posted in the social application.

4. The method according to claim 3, wherein obtaining the media data from the media database comprises:
selecting a keyword for obtaining the media data based on the interaction event; and
retrieving the media data from the media database based on the keyword.

5. The method according to claim 4, wherein selecting the keyword comprises:
identifying an object that is associated with the interaction event; and
selecting the keyword based on the object.

6. The method according to claim 1, wherein providing the media data to the second user account comprises: providing the media data to the second user account in response to any of:
a detection that the second user account finishes viewing an article that is posted in the social application;
a detection that the second user account submits a request to switch to a next article that is posted in the social application.

7. The method according to claim 1, wherein the interaction event comprises any of:
the second user account following the first user account;
the second user account viewing a profile of the first user account;
the second user account viewing an article that is associated with the first user account;
the second user account submitting a comment on an article that is associated with the first user account;
the second user account submitting a like comment to an article that is associated with the first user account;
the second user account forwarding an article that is associated with the first user account.

8. The method according to claim 1, wherein providing the media data comprises: providing the media data to the second user account in response to a determination that an occurrence time point of the interaction event meets a predetermined condition.

9. An electronic device, comprising a computer processor coupled to a computer-readable memory unit, the memory unit comprising instructions that when executed by the computer processor implements a method for providing media data in a social application, the method comprising:
determining a first user account of the social application, the first user account being a business user account of the social application;
obtaining an interaction event between a second user account of the social application and the first user account, the second user account being a personal user account of the social application; and
providing media data associated with the first user account to the second user account based on the interaction event.

10. The device according to claim 9, wherein the media data is different from an article that is posted by the first user account.

11. The device according to claim 9, wherein providing the media data to the second user account comprises:
obtaining the media data from a media database associated with the first user account; and
providing the media data to the second user account during the second user account viewing articles that are posted in the social application.

12. The device according to claim 11, wherein obtaining the media data from the media database comprises:
selecting a keyword for obtaining the media data based on the interaction event; and
retrieving the media data from the media database based on the keyword.

13. The device according to claim 12, wherein selecting the keyword comprises:
identifying an object that is associated with the interaction event; and
selecting the keyword based on the object.

14. The device according to claim 9, wherein providing the media data to the second user account comprises: providing the media data to the second user account in response to any of:
a detection that the second user account finishes viewing an article that is posted in the social application;
a detection that the second user account submits a request to switch to a next article that is posted in the social application.

15. The device according to claim 9, wherein the interaction event comprises any of:
the second user account following the first user account;
the second user account viewing a profile of the first user account;
the second user account viewing an article that is associated with the first user account;
the second user account submitting a comment on an article that is associated with the first user account;
the second user account submitting a like comment to an article that is associated with the first user account;
the second user account forwarding an article that is associated with the first user account.

16. The device according to claim 9, wherein providing the media data comprises: providing the media data to the second user account in response to a determination that an occurrence time point of the interaction event meets a predetermined condition.

17. A computer program product, the computer program product comprising a non-transitory computer readable storage medium having program instructions embodied therewith, the program instructions executable by an electronic device to cause the electronic device to perform a method for providing media data in a social application, the method comprising:
determining a first user account of the social application, the first user account being a business user account of the social application;
obtaining an interaction event between a second user account of the social application and the first user account, the second user account being a personal user account of the social application; and
providing media data associated with the first user account to the second user account based on the interaction event.
